(19) United States
(12) Patent Application Publication
(10) Pub. No.: US 2015/0095095 A1
(43) Pub. Date: Apr. 2, 2015

(54) METHOD AND APPARATUS FOR MASS REPLICATION OF DIGITAL MEDIA

(71) Applicant: THOMSON LICENSING, Issy de Moulineaux (FR)

(72) Inventors: Ryan John Sorensen, Valencia, CA (US); William Gibbens Redmann, Glendale, CA (US)

(21) Appl. No.: 14/384,457

(22) PCT Filed: Nov. 15, 2012
(86) PCT No.: PCT/US2012/065142

§ 371 Date: Sep. 11, 2014

Related U.S. Application Data
(60) Provisional application No. 61/611,712, filed on Mar. 16, 2012.

(51) Int. Cl. G06Q 10/06; G11B 33/10

(52) U.S. Cl. CPC G06Q 10/06315; G11B 33/10
USPC 705/7.26

(57) ABSTRACT

A method for replicating content onto a storage device commences by prioritizing a set of content replication jobs in accordance with work orders associated with such content replication jobs to establish a current highest priority content replication job. Thereafter, the content specified by the current highest priority replication job is downloaded onto a storage device for distribution to a location specified in the work order associated with the current highest priority replication job.

### CROSS-REFERENCE TO RELATED APPLICATIONS

This application claims priority under 35 U.S.C. 119(e) to U.S. Provisional Patent Application Ser. No. 61/611,712, filed Mar. 16, 2012, the teachings of which are incorporated herein.

### TECHNICAL FIELD

This invention relates to a technique for mass replication of content onto storage devices.

### BACKGROUND ART

The presentation of digital cinema movies and the like requires the distribution of large amounts of digital content to digital cinema exhibition facilities (e.g., movie theatres). While some facilities can accept digital content delivered via satellite or other broadband mechanisms, the majority of digital cinema exhibition facilities, including those newly converting from film, will likely require the physical delivery of digital cinema content on storage devices, currently hard disk drives, for some time. Thus, the release of a digital cinema feature presentation intended for widespread distribution will consume many hundreds of hard disk drives, each distributed to an individual movie theater. Presently, most hard disk drives can accommodate a full-length motion picture release. As hard disk drives get larger, the possibility exists of putting multiple movies on a single drive. However, the particular combination of movies would need to match the schedule of the movie theater receiving that hard disk drive. Not every theatre plays a particular movie, and only a fraction of theatres would likely play some arbitrary combination of movies.

Present high-performance had disk drive replicators, such as the King-Hit XG1060 manufactured by YEH Co., Ltd. of Japan obtain peak duplication speeds by bulk copying track-for-track from a master hard disk drive to identically sized clone target hard disk drives. Limitations exist as to the effectiveness of this technique for high-speed creation of an individual or a short run of hard disk drives. For instance, to use a King-Hit replicator, an operator must have a master hard disk drive the same size as the clone target hard disk drive(s), which requires the incremental steps of copying content to the master hard disk drive from files stored in a content management system and verifying such content. This effectively doubles the content copying time for a master hard disk drive, and requires performing a series of handling steps that can lead to errors, such as the wrong content folder copied to the master hard disk drive, or the wrong master hard disk drive used for a duplication run. Once the operator obtains the master hard disk drive, the bulk replication process copies the entire contents of that hard disk drive, even if data only exists on a portion of the hard disk drive, which again can lead to doubling of copy times (e.g., if data were to only occupy a portion of the hard drive disk). The King-Hit replicator offers a mechanism to address this problem, but that mechanism requires one complete read of the master hard disk drive first, which means that the benefit only accrues to a second batch of clone target hard disk drives, not the first batch, so that small runs cannot benefit from this feature.

One mechanism that offers improved speed for bulk copying is “drive clipping” (also known as “Host Protected Area” or HPA), where a hard disk drive undergoes re-programming to resemble a smaller sized drive. However, this method requires the master hard disk drive and all the clone target hard disk drives be clipped to the same size. The master hard disk drive undergoes clipping in advance, followed by partitioning and formatting to establish sufficient space for the content intended for distribution. The King-Hit replicator then clips all the clone target hard disk drives to match the master hard disk drive and thereafter commences bulk replication. This technique suffers from the drawback of needing additional steps to undertake such clipping, and the propensity to introduce operator errors in the clipping process (and in subsequent use of the master hard disk drive or clone target hard disk drives during the “unclipping” process). Clipping further introduces a constraint that a master hard disk drive can become too small in the event of a need to add or update files that would increase the size of the content on that hard disk drive.

Thus, a need exists for a system that better manages the copying of content to a hard disk drive for shipment to a particular theatre so that theatre receives the correct data and the necessary copying and shipment occurs in an efficient manner with low risk of failure due to technical faults or operator error.

### BRIEF SUMMARY OF THE INVENTION

Briefly, in accordance with a preferred embodiment of the present principles, a method for replicating content onto a storage device commences by prioritizing a set of content replication jobs in accordance with work orders associated with such content replication jobs to establish a current highest priority content replication job. Thereafter, the content specified by the current highest priority replication job is downloaded onto a storage device for distribution to a location specified in the work order associated with the current highest priority replication job.

### BRIEF DESCRIPTION OF THE DRAWINGS

FIG. 1 depicts a block diagram of content replication system in accordance with a preferred embodiment of the present principles;

FIG. 2 depicts a detailed block diagram of a portion of the content replication system of FIG. 1

FIG. 3 depicts an illustration of one bank of drive bays within the content replication system of FIG. 1

FIG. 4 depicts another illustration of the bank of drive bays of FIG. 3;

FIG. 5 depicts an exemplary schematic view of the bank of drive bays of FIGS. 3 and 4 connected to a replication server comprising part of the replication system of FIG. 1;

FIG. 6 depicts a process in flow chart form for collecting drive bay configuration data from one or more drive arrays of the banks of drive bays;

FIG. 7 depicts a process in flow chart form for collecting drive configuration data;

FIG. 8 depicts a state diagram for an exemplary replication job;

FIG. 9 depicts a state diagram for each drive while residing in a drive bay such as illustrated in FIGS. 3 and 4; and

FIG. 10 depicts a state diagram for the total life cycle for a storage device.

### DETAILED DESCRIPTION

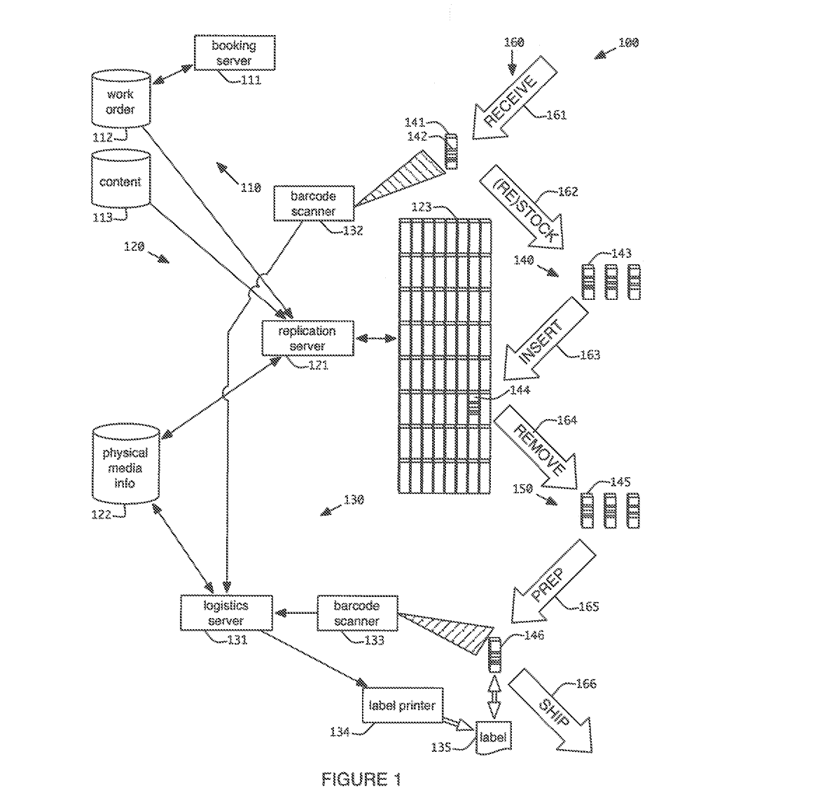

FIG. 1 shows a block diagram of a system 100 for booking, replicating and distributing storage devices with content, and an associated booking, replication and distribution process 160, both in accordance a preferred embodiment of the present principles. The system 100 comprises a booking system 110, a replication system 120, and a distribution system 130. Each of the booking system 110, replication system 120, and distribution system 130 will be described in the context of the overall system 100.

The booking system 110 comprises a booking server 111 and a work order database 112. Movie studios, other content owners, or agents for them, can all interact with the booking server 111 to enter work orders which specify the replication of content onto one or more storage devices (e.g., hard disk drives) for distribution to one or more movie theaters. An example of such interaction between a content owner or its representative and the booking system server 111 typically occurs when the content owner or its representative logs into the booking server 111 through a secure user interface typically over the Internet or another network or combination of networks (e.g., WAN(s) and/or LAN(s), for example). Using the booking server 111, the content owner or its representative can to log into a corresponding account and issue work orders for replication of specific pieces of content associated with that account (i.e., content which the account holder has the authorization to control replication). As mentioned, each work order identifies specific content for replication onto one or more hard disk drives for distribution to specific site(s), typically motion picture theaters. A work order database 112 stores such work orders entered through the booking system server 111.

The replication system 120 comprises a replication server 121, and one or more replication arrays 123 for holding individual hard disk drives described hereinafter. Presently, hard disk drives remain the preferred storage media for distributing content (e.g., digital cinema presentations) to movie theaters, given their relatively high storage capacity, low cost and small size. However, technological developments could lead to other types of storage devices that could serve as suitable replacements. As will become better understood hereinafter, the replication process of the present principles could readily accommodate other storage devices as they become available by making use of a suitable replication array (not shown) to interface to such storage devices.

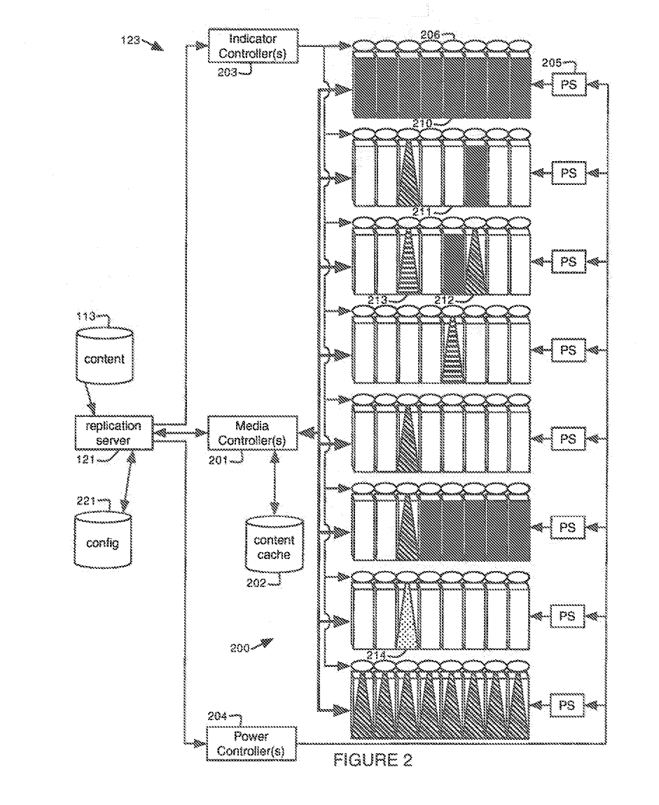

The replication server 121 accesses the work order database 112 since work orders serve to drive the operation of the replication system 120. The replication system 120 accesses a content store 113 comprising a network storage facility and/or an inventory of physical disk drives for storing content for replication onto the hard disk drives. Typically, the content held by the content store 113 gets preloaded by an ingest procedure, or the content is created in content store 113 by post-production operations performed on previously unfinished content. Alternative sources for content could exist in place of, or in addition to the content store 113 as discussed further in conjunction with FIG. 2.

The booking system 110 can take different forms. For example, the booking system 110 could comprise the Theatrical Distribution System (TDS) offered by Cinedigm Digital Cinema Corp., of Morristown, N.J. Alternatively, the booking system could comprise the Studio Portal offered by Technicolor Digital Cinema, of Burbank, Calif. Several major movie studios use one or more of these products for booking movies, while others have developed their own booking systems. The term “booking a movie” refers to the process of entering a work order to request replication of one or more pieces of content (e.g., digital cinema presentations) onto one or more hard disk drives for shipment to one or more movie theaters. The replication of one or one or more pieces of content onto a hard disk drive constitutes a replication job. Thus, a work order will specify at least one, and possibly multiple replication jobs.

Regardless of the specific type of booking system 110 that exists, the replication system 120 can access the resulting records (work orders) in the work order database 112 to determine the content needed for specific destinations (movie theaters). In some embodiments, where multiple booking servers 110 exist, the work order database 112 will have one or more adaption layers (not shown) to provide an interface to the particular booking system. In an alternative embodiment, the multiple booking servers 110 could each have a corresponding work order database 112, in which case, the replication server 121 would have the ability to access each such work order database.

The replication server 121 has the ability to derive and prioritize replication jobs from the work orders in database 112. Prioritization typically depends on many factors and can take account of due dates, delivery schedules, availability of content (e.g., the content existing in the content store 113), explicitly supplied work order priorities (e.g., a “rush” order), and/or work order priority policies (e.g., all things being equal, long-time customers take priority over new customers; large orders take priority over small orders). Regardless of the type and number of booking systems 110, the work order database 112 provides the interface between each booking system and the replication system 120.

The replication system 120 interfaces with the distribution system 130 at three places: First, the replication system 120 interfaces with the distribution system 130 though a physical media information database 122 used by both the replication server 121 and a distribution logistics server 131 to track the status of individual hard disk drives as described hereinafter. Second, the distribution system 130 receives physical media, in the form of one or more hard disk drives 141 staged in an inbound inventory 140 for use in the replication system 120. Third, hard disk drives such as the hard disk drive 145, already successfully written by the replication system 120 according to a work order, are staged for shipment in an outbound inventory 150.

Generally, a work order takes the form of a list of content for distribution and a list of one or more distribution targets (e.g., movie theaters) destined to receive that content. Some work orders, or portions of them, can be fulfilled by electronic distribution (e.g., broadband or satellite transmission), depending upon the capability of the recipient movie theater to respond to the instructions of the booking entity. Electronic distribution systems exist separately and typically would not interface with the replication and distribution systems 120 and 130, respectively, described and illustrated herein.

The work order can provide additional information, such as the show date and the length of run. From the show date, the replication server 121 can determine possible shipping dates, using rules based on the available shippers, classes of shipping (e.g., courier, next-day-first, next-day, second-day, etc.), and the corresponding costs. The possible shipping dates and costs constitute factors taken into account when optimizing the priority of individual replication jobs. A small job might undergo a delay and incur higher shipping costs so that a large job can complete in time to ship more inexpensively. The length of run is used by a key generation system (not shown) to provide keys for each recipient to decrypt encrypted content for play out during the booked show dates. If a booking becomes subsequently extended, the key generation system will need to generate new keys for an exhibitor, though generally no additional replication and distribution of content becomes necessary. Note that not all content requires encryption. Typically, only feature presentations undergo encryption, but not trailers or advertisements.

The distribution system 130 comprises a logistics server 131 that can access the physical media information database 122, and a set of barcode scanners 132 and 133 as well as other devices (not shown) to read identifying indicia carried by the hard disk drives. The logistics server 131 also has access to one or more shipping label printers, such as label printer 134, for printing a shipping label 135 to identify the shipping location for a hard disk drive.

The replication and distribution process 160 generally proceeds in the following manner. An incoming storage device, e.g., incoming hard disk drive 141 available for storage of content, undergoes receipt in the replication system 120 during step 161 at which time, the bar code scanner 132 scans the identifying indicia 142 on the hard disk drive for registration by the logistics server 131. The logistics server 131 will then update the status of that hard disk drive to “ready inventory” as the hard disk drive undergoes restocking in the inbound inventory 140 as a “ready drive” 143 during step 162. (A ready drive connotes a hard disk drive ready to receive content). These steps recur multiple times over the life of a hard disk drive each time a motion picture theater returns a drive after completing exhibition of the content contained on the drive.

As needed, an operator (not shown) can pull an arbitrary hard disk drive 143 from the inbound inventory 140 and insert that hard disk drive into the replication array 123 as “in bay” drive 144 during step 161. (An “in bay” drive connotes a hard disk drive that now resides in the replication array 123 for receiving content). The hard disk drive remains in the replication array while being erased, tested, filled, and tested again under the direction of the replication server 121. Upon completion of the replication job, the hard disk drive, is identified (as discussed below) leading to in bay drive 144 being removed during step 164 and placed in the outbound inventory 150 as a “ship” hard disk drive 145. The replication server 121 sets the status of this hard disk drive to indicate in the physical media information database 122 that the ship hard disk drive 145 should undergo shipping to the location specified in the corresponding work order in the work order data database 112.

During step 165, the “ship” hard disk drive 145 undergoes preparation for shipment and in doing so becomes the “completed” hard disk drive 146. Such preparation for shipment includes scanning the indicia 142 on the ship hard disk drive 145 by the barcode scanner 133. The logistics server 131 uses the information obtained by scanning the ship hard disk drive 145 to access the physical media information database 122 to retrieve the shipping information. Thereafter, the logistics server 131 sends the shipping information to the label printer 134 to produce a shipping label 135 applied to the “completed” hard drive and/or its shipping container. During step 166, the completed hard disk drive gets shipped to the corresponding movie theater, and logistics server 131 updates database 122 to set the status of the completed hard disk drive 146 as “out.” The logistics server 131 can track the progress of drives listed as “out” by communicating with information systems (not shown) maintained by the shipping company designated to ship the hard disk drive. Drives remain “out” until their discovery during step 161 upon receipt as an incoming drive. As described, the system 100, and particularly, the replication system 120 and the associated replication and distribution process 160 provide improved replication and distribution by prioritizing replication jobs in accordance with corresponding work orders.

FIG. 2 depicts a more detailed block diagram of content replication system 120 to illustrate components that comprise an exemplary configuration of the replication array 123. Here, the replication array 123 comprises an array 200 of docking bays, some shown empty (e.g., the docking bay 210), whereas some contain a hard disk drive, like the docking bay 211. Each docking bay has an associated indicator, e.g., the indicator 206, in immediate, unambiguous physical proximity to the docking bay. Each indicator is controlled to indicate the status of the corresponding hard disk drive or the bay itself, if empty. The indicators 206 can be viewed directly, or can project light onto the drives themselves (as shown).

Different animations and different colors convey status information to an operator having the responsibility of servicing the replication array 123. For example, a pulsing blue light can indicate a hard disk drive in a bay actively receiving content, whereas a steady green light 212 indicates a drive fully populated with content and ready for shipping. A blinking red indication 214 can identify a hard disk drive that has repeatedly failed quality tests and should be discarded. While the indicators 206 could provide many more details about the status of an individual hard disk drive, the indicators primarily provide an indication of what activity should occur next (e.g., “ship this drive”) or not (e.g., “do not interrupt, this drive is being written”). The brightness or speed of an animation can convey a sense of urgency, e.g., a fast blinking green could represent a high priority shipment as compared to a steady green meaning “ready to ship” with normal priority.

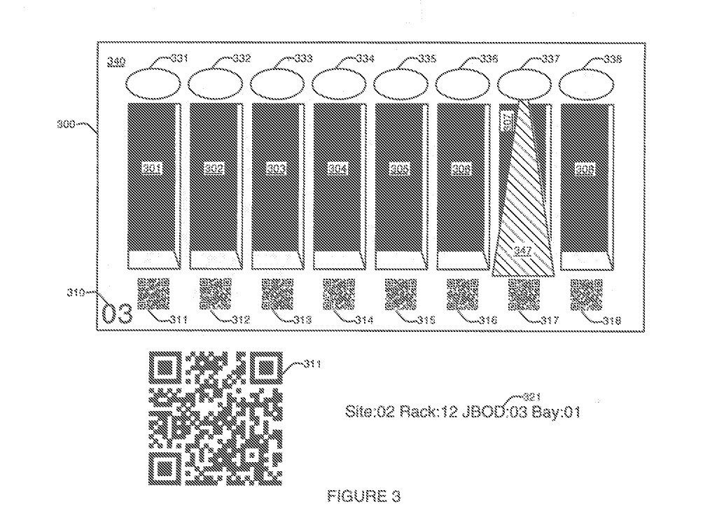

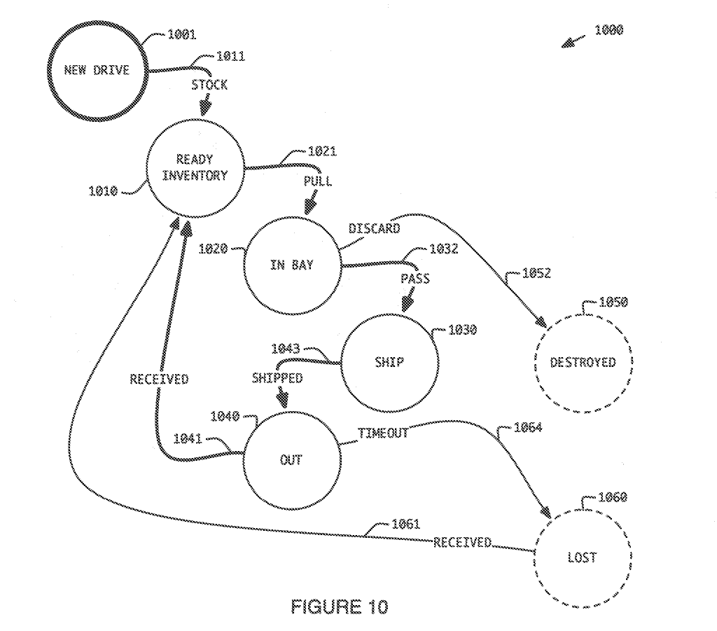

An indicator controller 203 controls the individual indicators (e.g., indicators 206) responsive to commands from the replication server 121. Thus, as the replication server 121 updates the status of each hard disk drive (or docking bay, as shown in FIG. 3), the corresponding indicator will reflect that change. Each docking bay has a corresponding power supply 205 which other docking bays can share. Each power supply 205 remains under the control of a power controller 204 responsive to the replication server 121. This allows the replication server 121 to save energy by powering down those hard disk drives in the array 123 not in use, as well as to power cycle hard disk drives as needed during certain drive initialization functions (e.g., drive clipping, also known as “Host Protected Area” (HPA), discussed below in conjunction with FIG. 10).

The replication server 121 further controls one or more media controllers 201 connected to each hard disk drive bay in the array 200. Additionally, a content cache 202 can serve to buffer content, as in the case of a RAID (redundant array of inexpensive disks), so that when copying content to the hard disk drives in the array 200, the replication server 121 does not need to rely completely on the bandwidth available from its connection to the content store 113. In some embodiments, an operator could insert a master hard disk drive (not shown) into a designated docking bay in the array 200 to supply content pulled from that drive for writing onto to target hard disk drives in other docking bays. If needed, the replication server 121 can maintain a configuration database 221 that records the association between an individual docking bay (e.g., docking bay 210), an individual indicator (e.g., 206), and as needed, the corresponding controller 203 for that indicator, the media controller 201, and power controller 204, and the appropriate port or other hierarchical designation for each device.

In one embodiment, the array 200 of docking bays comprises a multiple rack-mounted set of docking bays for hard disk drives, such as the rack-mounted set of docking bays 300 shown in FIG. 3. The front panel 340 of the rack-mounted set of docking bays 300 has openings for each of eight docking bays 301-308, each labeled by corresponding one of barcodes 311-318, respectively. Each of docking bays 301-308 corresponds to one of indicators 331-338, respectively. When lit, an indicator, such as the indicator 337, become visible for direct viewing, or can provide a light stream 347 that illuminates the corresponding docking bay 307 (or a drive occupying bay 307, when populated, not shown in FIG. 3). The rack-mounted set of docking bays 300 can provide human readable indicia 310 or machine-readable indicia 311-318, which could comprise striped barcodes or, as shown in FIG. 3, two-dimensional barcodes such as quick response (QR) codes. In this example, the QR code 311 contains the information 321 to identify the site, rack number, position number, and docking bay number of the corresponding docking bay 301. This enables each docking bay to have a unique identification regardless of its location, which can be useful when multiple replication sites and distribution points exist and addressing of each docking bay becomes necessary.

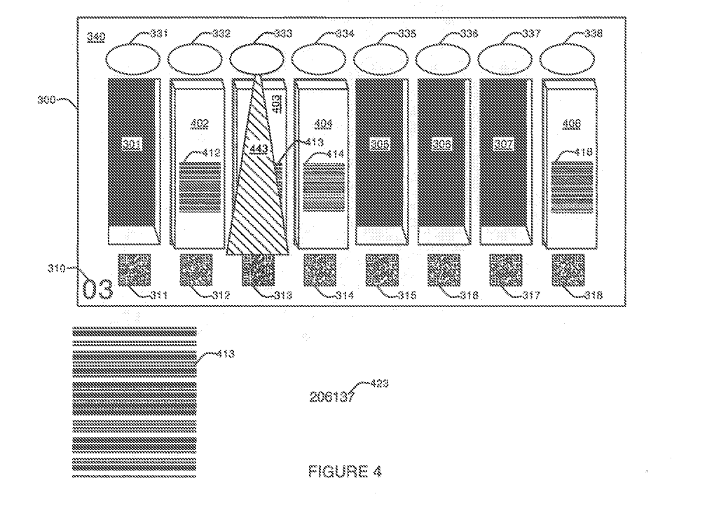

FIG. 4 shows the same rack-mounted set of docking bay 300 as FIG. 3, with several of the docking bays, e.g., docking bays 302-304, 308, occupied by hard disk drives 402-404, 408, respectively, each labeled with corresponding one of drive indicia 412-414, and 418, respectively. In FIG. 4, the drive indicia comprise barcodes but could take other forms as previously described. In an occupied bay, e.g., docking bay 303, the emitted light 443 from the corresponding indicator 333 now indicates the status of the hard disk drive 403 in that bay. Each drive indicia such as indicia 413 encodes a unique identifier 423 in machine-readable form. The identifier 423 is stored in the physical media info database 122, and typically represents or is associated with a serial number of the hard disk drive 403, or some other form of unique identifier corresponding to drive 403 that is electronically readable by replication server 121 through the media controller 201.

The relationship between the identifier 423 encoded by the indicia 413 and the electronically readable serial number of the hard disk drive 403 allows the replication server 121 to uniquely recognize that particular hard disk drive when inserted into any of the docking bays in the array 200. By associating the record for the hard disk drive 403 stored in the physical media information database 122 with a specific distribution destination specified in a work order, then the logistics server 131 will have enough information after reading of the indicia 413 by the bar code scanner 133 to retrieve the shipping address of the distribution destination and other information necessary for label printer 134 to print an appropriate shipping label 135.

As thus described, the replication server 121 has the ability to automatically associate a work order or distribution destination with a particular hard disk drive inserted in the array 200 without human intervention. Further, the logistics server 131 has the ability to later recognize that relationship for generating the shipping label 135 in a manner substantially immune to error-prone human intervention. Thus, the combination of the replication server 121 and the logistics server 131 serve to automatically replicate hard disk drives and automatically label them for shipment, thereby dramatically improving the reliability and accuracy of drive shipments and increasing the efficiency of an operators inserting hard drives into and removing hard disk drives from replication array 123 during steps 163 and 164 of FIG. 1.

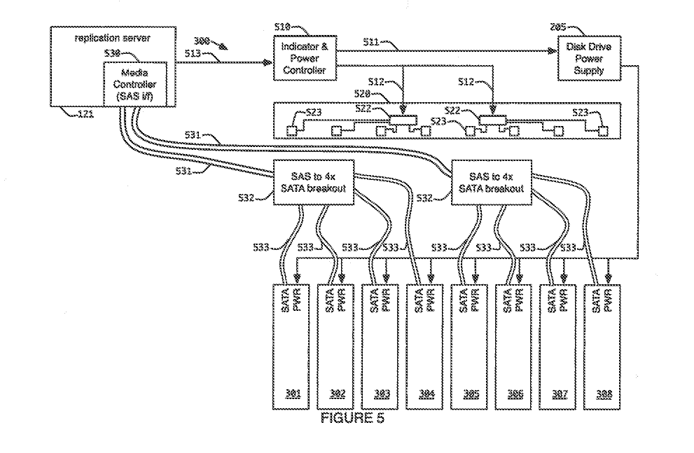

FIG. 5 shows the details of an exemplary embodiment of the rack-mounted set of docking bays 300 and its interconnection to the replication server 121. Each set of rack mounted docking bays, such as set 300, has a separate SATA (Serial ATA) and power connection, such as found in the 4U, 8 Bay ‘RAX845DC’ rack-mounted drive bay set manufactured by CRU-DataPort of Vancouver, Wash., for use with hard disk drives enclosed in a compatible carrier, e.g., their ‘DX115 DC—Carrier Only’. In practice, the replication server 121 can comprise a Proliant DL370 G6 server manufactured by Hewlett-Packard Company of Palo Alto, Calif. with the media controller 530 implemented as a model ‘9201-16E’ SAS (Serial Attached SCSI) interface manufactured by LSI Corporation of Milpitas, Calif. The media controller 530 (of which media controller 201 may comprise one or more) is connected via separate, multi-lane SAS cables 531 to corresponding multi-lane SAS-to-SATA 4-way breakout cards 532, such as the ‘4×SATA to SFF-8470 PCI Host Adapter’ included in the RAX845DC rack-mounted docking bay set. Each docking bay 301-308 receives its own dedicated SATA connection 533 via one of breakout cards 532. In this way, each hard disk drive plugged into a docking bay in the rack-mounted set of docking bays 300 has a full bandwidth connection to the replication server 121. A single replication server 121 can address at least 64 individual docking bays in this way.

The docking bays 301-308 receive power from the power supply 205, enabled through a control line 511 by the indicator and power controller 510. The indicator and power controller 510 also commands the LED controller circuits 522 (e.g., the ‘PCA9622’ by NXP Semiconductors Netherlands B.V. of the Netherlands) on a light board 520 through an I2C (inter-integrated circuit) communication bus 512. On the light board 520, the tri-color LEDs 523 each implement one of indicators 311-338. The connection 513 between the replication server 121 and the controller 510 can comprise Ethernet link. Thus, in this exemplary embodiment, the indicator and power controller 510 implements both the indicator controller 203 and power controller 204 within each rack-mounted set of docking bays 300.

In an exemplary embodiment, the indicator and power controller 510 can comprise an Ethernet-enabled Arduino processor (for example, the Arduino processor marketed by SparkFun Electronics of Boulder, Colo. or a variant, the Netduino marketed by Secret Labs, LLC of New York, N.Y.). The Arduino processor can drive the I2C bus 512 (directly) and power control line 511 (through an opto-isolator) in response to commands received from the replication server 121 through a web service offered by the Arduino processor. In an alternative embodiment, the power supplied to individual docking bays 301-308 could be individually controllable.

In practice, the controller 510 can provide a selection of different animations, each accepting one or more parameters, such as color, brightness, and/or speed. Following selection of a particular animation for a particular indicator, the controller 510 will update the output of that indicator repeatedly, for example thirty times per second, in accordance with the selected animation and parameters. For example, the animation could take the form of pulsing, where the output of the lamp brightens and dims each interval according to the equation

PulseAnimationOutput=C*(sin(F*2π*t)+1.0)/2

in which ‘C₁’ is a color parameter that the indicator should display at its brightest, and ‘F’ is the frequency of the pulsing in Hertz (cycles per second). The value ‘t’ represents the current time of a clock (not shown) maintained by the controller 510. In this embodiment, the color parameter C₁ represents the three color components red, green, and blue as a triplet. An exemplary value for C₁ could be {1.0, 0.5, 0.0}, which would represent 100% red, 50% green, and 0% blue, resulting in a display as bright orange. In this embodiment, clamping serves to keep the color components of any animation function within the range of 0-100%. For a given animation scheme, color and speed are changeable by parameters, but any two indicators provided with the same pulse frequency will be synchronous by virtue of being derived from the same clock time ‘t’.

Other simple ‘animations’ could include alternating color values:

TwoColorBlinkOutput=(sin(F*2π*t)>0)?C₁:C₂

Where the tertiary operation COND ? RESULT1: RESULT2 evaluates the condition of the first expression (COND), and if true, returns the first result (RESULT1), and if false, returns the second result (RESULT2). Thus, this second animation scheme accepts two colors, ‘C₁’, ‘C₂’ and a frequency ‘F’ as parameters, and twice per cycle toggles between colors C₁ and C₂. C₁ and C₂ might be distinct colors, (e.g., red and blue), two different intensities of the same color, (e.g., bright red and dim red), or one color and black. Slower animations can be obtained using frequencies less than one, or using period ‘P’ as an alternative parameter, for which an example animation formula might be:

TwoColorBlinkSlowOutput=(sin(2π*t/P)>0)?C₁:C₂

Where ‘P’ is given in “seconds per cycle”.

Of course, animations scheme can be arbitrarily simple or complex. A solid color would result from the trivial animation function “Solid=C₁”, which does not vary as a function of time. Different phases could be applied to individual indicators to create graceful patterns across the set of indicators on a plurality of arrays 200. The controller 510 could generate an animation command for a particular indicator to produce a spatial animation across the front panels of the replication system 120. For example, the controller 510 could power down “ready” hard disk drives in the absence of any tasks for such disk drives. An animation applied to the indicators for such these hard disk drives could produce a subtle blue wave, which periodically sweeps across the front panel of the replication array 200, starting in the first column of the first row of the first rack and proceeding both downward and rightward to consecutive rows and columns and through adjacent racks. Such a wave would indicate which systems remain ready, but not presently busy, without each hard disk drive calling so much attention to itself as to distract from the indicators of those hard disk drives actually engaged. The following comprises an example of such an animation:

WholeArrayWave=C/(1−a)*(sin(2π*t/P−(b_{X}+r_{X}*RSF+j_{X}*JSF)/ASF)−a)

Where b_{X}, r_{X} and j_{X} represent values corresponding to Bay, Rack, and rack-mounted docking bay numbers (e.g., as in the information message 321) for each docking bay (e.g., docking bay 301). ‘RSF’ represents a rack-scale-factor aesthetically selected to best map the wave horizontally so that it appears to flow smoothly from rack to rack (which for the examples shown, e.g., in FIG. 3, might be between 8 and 12). Similarly, “JSF” represents a rack-mounted docking bay set-scale-factor selected to aesthetically map the wave vertical progression from the top rack-mounted docks to the bottom, which might be from 4 to 8 for the example rack-mounted docking bay set shown in FIGS. 3 and 4. The parameter “a” serves adjust to narrowness of the wave and can take values −1<a<1. The parameter “a” will produce narrow waves for values above 0.95, and a half-on/half-off wave at 0. As before, ‘C’ represents the color presented by an indicator at its brightest point during in the animation. As described above, for values where the animation function returns a color component value less than 0, the value is clamped to 0.

Even with just a few different animations provided by the controller 510, the replication server 121 can provide a variety of quickly discernible different indications of various intuitively readable degrees of urgency or severity. A solid, but dim red could indicate a hard disk drive that failed during a copy operation. A bright, rapidly blinking red could indicate a disk that, having repeatedly failed tests and resisted recovery attempts, should be discarded. A solid green light could indicate a hard disk drive ready to ship, whereas a rapidly blinking green could indicate the most urgent shipment. Pulses (as described above) will like prove less annoying to an operator than hard blinking, and therefore more suitable for long operations in progress or idle status. Animations advantageously demonstrate active communication over the bus 512, which effectively demonstrates that the controller 510 remains active and non-black values for indicators that demonstrate that the system remains powered.

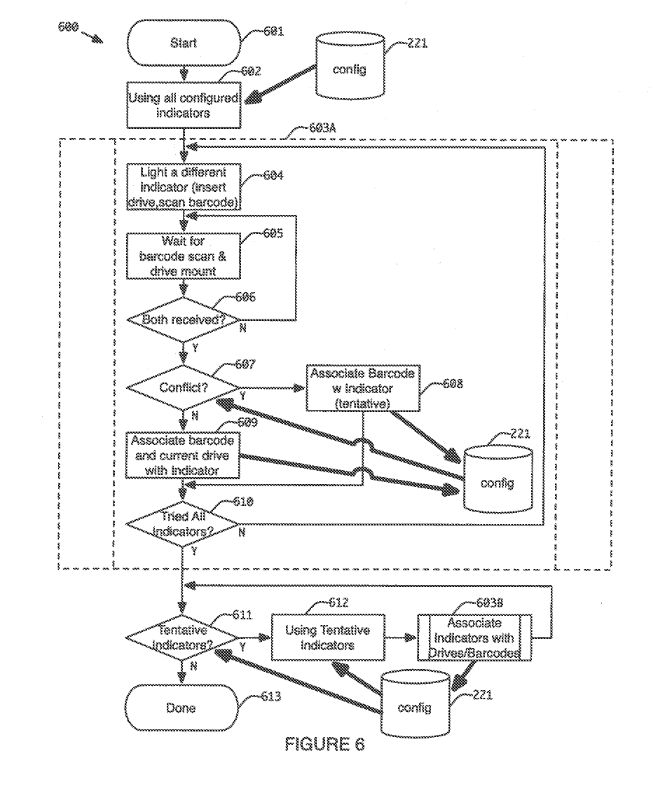

The replication array configuration process 600, shown in FIG. 6, serves to ensure that the replication server 121 knows for each of indicator light 206 (corresponding to which particular controller 510, light board 520, and LED 523), which media controller 530 and the wiring harness comprising cables 531 and 533 corresponds to the physically proximate docking bay 210. This correspondence could exist a priori. However, greater reliability results from establishing or confirming the association, especially upon installation or replacement of any of the components in replication system 120. The replication array configuration process 600 begins upon execution of step 601, with the indicator controller 203 and power controller 204 (which in the example embodiment of FIG. 5 are both embodied by the indicator and power controller 510) listed in a configuration database 221. The configuration of each controller (e.g., the controller 510) includes a fixed IP address, typically recorded in the configuration database 221. Alternatively, the configuration database 221 could include the fixed MAC address of the controller. In yet another alternative embodiment, each controller 510 could obtain an IP address dynamically, and respond to a broadcast query or poll from the replication server 121, or otherwise announce itself. Thereafter, the replication server 121 would learn that dynamic IP address and corresponding fixed MAC address of each controller 510 for recording in the configuration database 221.

During execution of step 602, the replication server 121 accesses the configuration file to recall an address corresponding to each of the controllers 510 that controls the indicators. (In event that separate indicator controllers exist, the replication server 121 would address such controllers during step 602.) Upon initial execution of the process 600 of FIG. 6, the sub-routine 603A undergoes execution to determine the configuration of every indicator controlled by every controller. Upon execution of step 604, the replication server 121 will command different indicators to light (e.g., indicator 337 in FIG. 3) while extinguishing other indicators. At this time, an operator can insert a single hard disk drive into the identified docking bay 307 and scan the corresponding indicia 317 with an appropriate scanner (not shown) in communication with the replication server 121. During step 605, the process waits for scanning of the indicia 317 by the operator and for the operating system to respond to the newly mounted hard disk drive. During step 606, a test occurs to determine whether scanning of the indicia 317 and mounting of the hard disk drive has occurred. If not, the processes loops back to step 605.

When the operator inserts a hard disk drive in the array 200, a query to the operating system can determine the hardware device path for the just-inserted hard disk drive. A portion of that hardware device path will invariably correspond to the docking bay 307. This invariant portion of the device path will aid determining the existence of a newly inserted hard disk drive in the docking bay 307, which corresponds to the indicia 310 and the indicator 337. However, if the operator configuring the array 200 has made a mistake, such as having scanned the wrong indicia (e.g., the indicia 316), or inserting the hard disk drive into the wrong docking bay (e.g., the drive bay 306), then in the course of determining the configuration of all the indicators specified during step 602, a conflict will likely arise. For this reason, during step 607 a test occurs to determine whether either of the scanned indicia or the invariant portion of the drive device path has been previously encountered and entered into the configuration database 221 in association with any indicator or indicators other than the current one (e.g., the indicator 307). If so, then a conflict exists and process execution branches to step 608, during which time the entries in the configuration database 221 for each of the ambiguous associations, previous and current, undergo updating to indicate their status as tentative, after which process execution branches to step 610.

If during step 607, no conflicting prior entries exist in the configuration database 221 for any of the current indicators (e.g. the indicator 307), the scanned indicia, or the invariant portion of the hard disk drive device path, then during step 609, the configuration database 221 records the indicator (e.g., the indicator 337), the indicia (e.g., the indicia 317), and the invariant portion of the device path for the hard disk drive in the docking bay (e.g., the docking bay 307) and again, the process branches to step 610. During step 610, testing occurs made to determine whether any indicators remain for configuration in the present call to the sub-routine 603A. If so, then the process loops back to step 604 and the next remaining indicator becomes lit. During step 605, the operator can insert a new hard disk drive into the newly indicated docking bay. Alternatively, the operator can remove the hard disk drive previously inserted during the prior iteration and use that drive instead in each subsequent iteration.

If the testing conducted during step 610 determines no more indicators require configuration in the present call, then sub-routine 603A exits and process execution branches to step 611. During step 611, a check occurs for the existence of any entries for indicators marked as “tentative” in the configuration database 221. If so, then step 612 undergoes execution to erase those tentative records and re-submit the previously “tentative” indicators to the indicator configuration determining routine 603B (a distinct call to the same routine shown as 603A). As a result of this subsequent call to the indicator configuration determination routine, the configuration data base 221 will record a new association for each of the previously tentative indicators, indicia, and docking bay device paths, with the likelihood being that the operator will have corrected all or most of the errors. Then, upon returning to step 611, the testing of the configuration database 221 undertaken during that step will eventually find no ambiguous (tentative) records and processing will complete upon execution of step 613. From this point onward, on the basis of a device path reported for a hard disk drive newly inserted into an arbitrary docking bay, the replication server 121, by accessing the configuration database 221, can determine the docking bay containing the newly inserted hard disk drive and which indicator corresponds to that location.

Assuming the wiring harnesses comprising cables 531 and 533 possess high quality and certainty of configuration, and assuming the ability to correctly predict the assignment of IP addresses or other configuration information of the controllers 510 and, 203; then all or most of the configuration information obtainable with process 600 can be predetermined and provided in the configuration database 221 directly. Under such circumstances, the process 600 may be simplified or eliminated in its entirety.

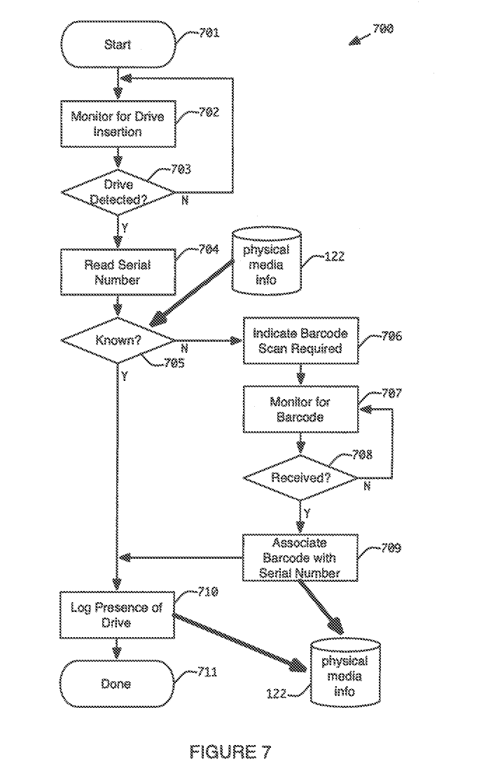

When the configuration database 221 contains information about the docking bays in the array 200, a drive-logging process 700, shown in FIG. 7, can run. The drive logging process 700 begins upon execution of step 701 during which the replication server 121 monitors for an indication that an operator has inserted a hard disk drive into the array 200. In some example embodiments, the replication server 121 can monitor for such an indication by periodically scanning the hardware hierarchy, i.e., traversing the paths for the hard disk drives and looking for new entries. In an exemplary embodiment, the process 700 could receive a notification of the addition of a hard disk drive during step 703. If the execution of step 703 reveals no newly added hard disk drive, the process then branches to step 702 to wait. However, upon the addition of a hard disk, step 704 undergoes execution, whereupon, the replication server 121 reads the hard disk drive identifier (e.g., the serial number) from the hardware parameters.

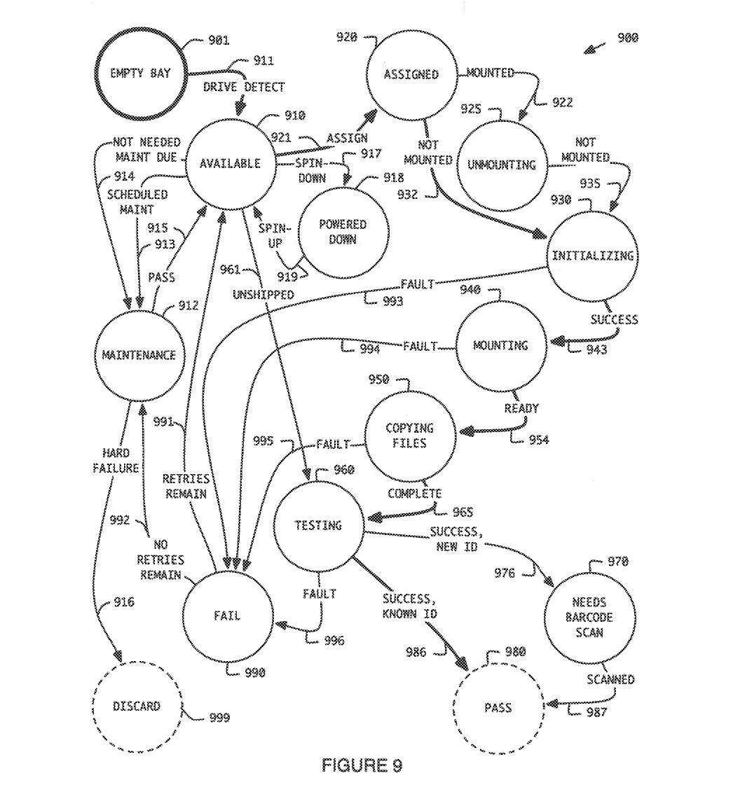

At step 705, a query to the physical media information database 122 can determine whether the system 100 has already registered the newly inserted drive. If so, process execution branches to step 710, whereupon the in physical media information database 122 logs the hard disk drive as being AVAILABLE, as discussed further in conjunction with FIG. 9. The process then concludes upon the execution of step 711. If, upon the execution of step 705, the query of the physical media information database 122 does not recognize as registered the serial number of the newly inserted hard disk drive, then process execution proceeds to step 706. During step 706, the replication server 121 generates an indication to an operator of a need to scan the barcode of the newly inserted hard disk drive. For example, the replication server 121 could flash the indicator 333 with a color that indicates the need to scan the barcode 413 on hard disk drive 403 in docking bay 303 of the rack-mounted set of docking bays 300.

During step 707, the system 100 of FIG. 1 waits for scanning of the barcode (e.g., the bar code 413), looping back from step 708 until scanning has occurred. Upon receipt of the barcode scan during step 709, the replication server 121 will extinguish the “scan needed” indication on indicator 333 and will now associate the hard disk driver identifier (e.g., the serial number) with the barcode by making a record in the physical media information database 122. In some cases, for example, when multiple drives indicate “scan needed”, scanning of both the docking bay barcode (e.g., the bar code 313) and the hard disk drive barcode (e.g., 413) may become necessary to resolve the ambiguity regarding the order of the scanning of the hard disk barcode. Upon resolution of the “scan needed,” processing continues upon execution of step 710.

In an alternative embodiment, for example the embodiment illustrated in FIG. 9, instead of indicating a “scan needed” during step 706, the “scan needed” condition would merely be logged in the physical media information database 122 and processing would continue during step 710. In this way, an operator loading hard disk drives into the array 200 need not stop loading to scan barcodes before other duplication processes could proceed. Rather, operations performed on the just-loaded hard disk drive, for example, the operations of testing, formatting, and copying, could proceed with the replication server 121 actually blocking progress until the hard disk drive was otherwise ready for removal and shipping. In this embodiment, recognition by the replication server 121 of a “scan needed” could be displayed on the corresponding indicator, while the scan might come anytime while the hard disk drive remains in the array 200. Upon satisfaction of the “scan needed” condition, the indicator could revert to the currently pertinent state. In still another embodiment, the “scan needed” indication could constitute a particular detail added to the other color and animation indications exhibited by the indicators. For example, “scan needed” might constitute be a brief blue flash inserted into the color/flashing/animation currently displayed by the indicator.

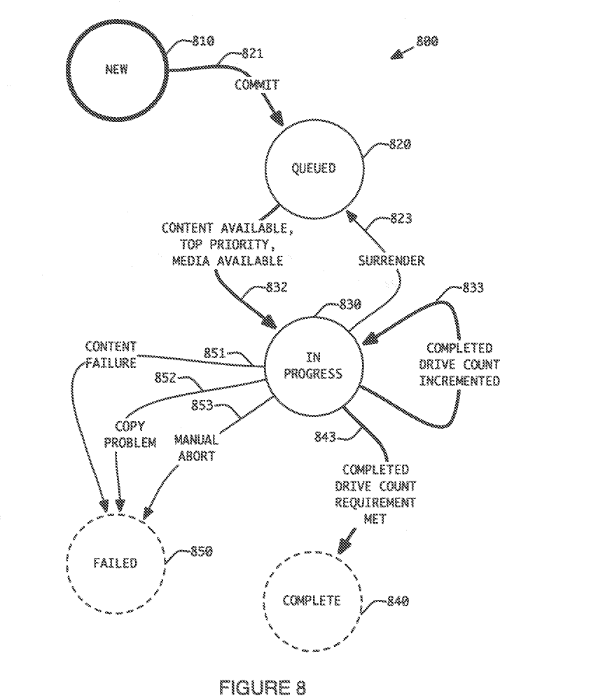

FIG. 8 depicts job state transition diagram 800 that illustrates the progression of states through which a replication job would typically proceed. Upon entry or acceptance of a work order from the booking system 110 of FIG. 1 into the work order database 112, a new replication job is created having the NEW state 810. The job becomes committed during the transition 821 and thereafter, the replication job obtains QUEUED status during state 820, whereupon, the replication job awaits: (1) the availability of the corresponding content in the content store 113, and (2) the availability of the necessary hard disk drive(s) to store content (e.g., following the drive logging process 700), and (3) the queued job advances to the top priority job. When these criteria are met, the transition 832 occurs and the replication job obtains IN PROGRESS status in the state 830 and one-by-one, the hard disk drives allocated to the replication job receive the appropriate content for copying (see the transitions 986 and 987 in FIG. 9), reducing the number of additional drives required for the replication job by one during the transition 833. Once the total number of drive(s) required for the replication job have undergone successful copying, the transition 843 occurs and the status of the replication job reaches the COMPLETE state 840.

If, however, while the replication job remains in progress during the state 830, a failure of the source content occurs resulting in transition 851 (e.g., the content checksums appear invalid), or a copy problem arises to produce transition 852, (e.g., the content database 113 becomes unavailable), or a manual abort has occurred initiating transition 853 (e.g., an operator cancels the work order), then the job transitions to the FAILED state 850. Once a job has entered the FAILED state 850, operator intervention (not shown) becomes necessary to return the replication job to the QUEUED state 820.

In some embodiments, the combination of a first replication job in the IN PROGRESS state 830 and a sufficiently urgent second job entering the QUEUED state 820 could result in the second replication job commandeering the hard disk drive(s) allocated to the first replication job. Under such circumstances, the first replication job will surrender via the transition 823 before returning to the QUEUED state 820, thus freeing the resources that had been allocated to the first replication job to be used by the second, more urgent replication job.

FIG. 9 shows a state diagram 900 associated with the drive bays during operation of the replication system 120 of FIG. 1. The EMPTY BAY state 901 corresponds to an empty docking bay (e.g., docking bay 304 in FIG. 3). Upon detection of the insertion of hard disk drive, such as hard disk drive 404 in FIG. 4 into a drive bay during drive logging process (represented as the drive detection transition 911), the drive bay status transitions to the AVAILABLE state 910 in FIG. 9, as occurs during step 710 of FIG. 7

While the drive bay status remains in the AVAILABLE state 910, a transition to MAINTENANCE state 912 is appropriate if the hard disk drive in that bay is not immediately needed and could reasonably accept maintenance (as via the transition 914) or gets designated as needing scheduled maintenance (as via the transition 913), wherein the drive will undergo testing and/or conditioning. In practice, many hard disk drives possess Self-Monitoring, Analysis and Reporting Technology’ (SMART) thus allowing the hard disk drive itself to determine when maintenance becomes necessary. Alternatively, records kept by the physical media information database 122 tracking hard disk drive failures or aging can also serve to indicate the necessity of hard disk drive maintenance. A hard disk drive that successfully passes testing and/or conditioning will follow transition 915 and returns to the AVAILABLE state 910. However, a hard disk drive that irrecoverably fails such testing and/or conditioning or fails sufficiently so that confidence in the drive becomes compromised will trigger transition 916 so that the drive status enters the DISCARD 999 state. When a hard disk drive enters this state, the replication server 121 sets a corresponding indicator to alert the operator to remove this hard disk drive from service.

In some embodiments, an available but currently unneeded hard disk drive situated in a rack-mounted set of docking bays docks filled with other unneeded hard disk drives could undergo spin-down by the power controllers 510 or 204, taking transition 917 of FIG. 9 to save energy and wear. Such hard disk drives would remain in the POWERED DOWN state 918, until needed for a replication job, whereupon the corresponding power controller would spin-up those drives, returning them to AVAILABLE state 910 via the transition 919. As hard disk drives spin-down or spin-up, the media controllers 201 and 530 typically will report this activity to the replication server 121 as a removal or insertion, respectively. The replication server 121 needs to track the status of the hard disk drives in such states to enable management of the drives and their corresponding power controllers through the POWERED DOWN state 918. In particular, the replication server 121 needs to remember that a rack-mounted set of docking bays has become powered off with its then-current inventory of otherwise available hard disk drives. Even in the POWERED DOWN state 918, the corresponding indicators will show the drives as ready (or a dimmed and/or slower, version of the ‘ready’ indication).

When a replication job in the QUEUED state 820 of FIG. 8 finds sufficient hard disk drives in the AVAILABLE state 910 of FIG. 9 (or as available and needed, wakes them from the POWERED DOWN state 918), and the other criteria specified in the transition 832 of FIG. 8 remain satisfied, the replication server 121 can assign hard disk drives to that replication job during transition 921 as the job enters the IN PROGRESS 830 state. The hard disk drives will then enter the ASSIGNED state 920. Once in the ASSIGNED state 920, if a hard disk drive is determined to have previously been mounted 922 (as may have occurred through certain testing, or as the normal state of drives when acquired by the operating system), then the hard disk drive enters the UNMOUNTING state 925 during which the hard disk drive undergoes un-mounting, then once the hard disk drive is determined to be un-mounted, the drive enters the INITIALIZING state 930 via transition 935. If, in the ASSIGNED state 920, the hard disk drive is already un-mounted, then transition 932 will take the drive to INITIALIZING state 930 directly.

While a hard disk drive remains in the in INITIALIZING state 930, the replication server 121 will know the total data size “S_{DATA}” for the replication job. There are several “sizes” to be considered with respect to a drive being processed in this state, which have the following relationship:

S_{PHYSICAL}≧S_{CLIP}>S_{PARTITION}>S_{FILESYSTEM}>S_{DATA}

where “S_{PHYSICAL}” is the total physical size of the hard disk drive. Some hard disk drives, if desired, can be “clipped” to a different, smaller size “S_{cu}p” by setting a value for the host protected area (HPA). Drive clipping causes the hard disk drive to appear physically smaller to the operating system and some replication devices can make bulk copying with such systems more efficient (i.e., a bulk copy, one made without knowledge of information structures on the disk, such as partitions and file systems). “S_{PARTITION}” is the size of the drive partition, which cannot exceed S_{PHYSICAL} (or S_{CLIP}, if set) and is generally a bit smaller, due to the space reserved for bad blocks and special records. The file system size, S_{FILESYSTEM}, is again, a bit smaller than the partition within which it resides, due to the tables needed to for the structure of the partition itself. Finally, the structures of the file system (e.g., file allocation tables or in nodes or the like) consume some amount of space, which ultimately constrains the size S_{DATA} of the data that will fit on the initialized drive.

In many systems, there is value in constraining the size of the partition, especially if S_{DATA} doesn't exceed about ⅔ of S_{PHYSICAL}. This is because most disks spin at a constant speed, and data cylinders at the outer radius of the disk can store more information than cylinders at the inner radius, which corresponds to the amount of data that can be read or written in a single revolution of the disk. The data transfer electronics of the drive may limit read and write rates that might otherwise be too fast when accessing the outer cylinders, but cannot sustainably speed up the slower data rates for the inner cylinders, thereby making the outer portion of the drive (empirically observed on some models of some brands of drives to be roughly the outer ⅔ cylinders) evenly performing, with the incremental speed degradation when reading or writing to cylinders progressing inward from there. So a smaller partition minimizes utilization of the lower performing (i.e., slower) portions of the disk.

There is another advantage to a smaller partition when the behavior of certain file systems is considered. The well-known file system FAT32, for instance, tends to write from the outer portion of the disk, to the inner portion, whereas EXT2 prefers to space a new files as far as possible from previously written files, so as to better mitigate issues of file fragmentation when files are later deleted. This would lead to files being scattered throughout a partition, resulting not only in utilization of the lower performing inner cylinders, but also more magnetic head movement than would otherwise been needed. Therefore, in some cases, smaller partitions will minimize the hard disk drive head movement during reading or writing.

For these reasons, the processing during INTIALIZING state 930 may take the job data size S_{DATA}, increase it by an amount (e.g., a predetermined percentage such as 2%, or predetermined amount such as 5 GB, or by a formula based on the particular file system type and parameters selected) to determine S_{FILESYSTEM}. That value may in turn be increased by an amount (e.g., a predetermined percentage or amount or a formula based on the partition type and parameters selected) to determine S_{PARTITION}. Finally, if desired, an appropriate clipping value S_{CLIP} may be selected. In generally, these are applied in reverse order: First, the drive is clipped, then partitioned, and then formatted with the file system. Clipping is commonly performed with a utility program, which in some cases may be manufacturer specific. Partitioning and formatting are utilities commonly provided by the operating system of the replication server 121.

For some operating systems, the process of clipping a hard disk drive requires that the drive undergo power-cycling (e.g., cycling the hard disk drive power supply 205 off and on) to completely expunge the records of the hard disk drive's previous apparent size from the media controller 530 and the operating system of replication server 121. This particular case is not shown in FIG. 9, as it is only required for certain operating system/media controller/drive model combinations. However, in such a cases, the hard disk drive requiring the power cycle is handled much in the same way as during the POWERED DOWN state 918: The replication server 121 commands the power controller 510 to cycle power on the corresponding docking bay. This will cause the hard disk drive to disappear from the hardware hierarchy. After restoring power, (which can occur within a fraction of a minute), the replication server 121 operating system will recognize the hard disk drive, but the replication server 121 retains the responsibility determining that the device path and/or drive serial number corresponds to a drive undergoing clipping, so that the drive immediately returns to the INITIALIZING state 930 to continue that part of the process.

If an initialization fault occurs during INITIALIZATION state 930, then the transition 993 is followed and the hard disk drive enters the FAIL state 990, but if initialization returns success, then the transition 943 occurs and the hard disk drive and in MOUNTING state 940, its new file system mounts. Here, too, a fault occurring initiates transition 994 and directs the hard disk drive to the FAIL state 990, but if successful, the hard disk drive becomes ready (transition 954) and enters the COPYING FILES state 950. While one or more hard disk drives remain in the COPYING FILES state 950 in association with the same replication job, various strategies can serve to maximize the rate at which files undergo successful copying. Generally, if a large number of hard disk drives (say, 50) copy the same large file, even if they start synchronously, their individual progress will diverge. The copy to the lead hard disk drive (the one currently furthest ahead in copy progress) will always request portions of the file not yet been cached, whereas other drives that are almost as far in copying gain a slight advantage insofar as their requests for the same portions will be satisfied with less delay, because the portion of the file needed for copying had already been requested by the leading hard disk drive, and will typically already reside in cache. However, there generally will be one or more drives that trail the pack of hard disk drives, and over the course of copying many thousands of sectors, the pack may be spread out such that the number of sectors between the one sector currently be requested for the lead hard disk drive and the one sector being requested by the trailing drive will just exceed the cache size. At this instant, the next request made by some drive not in the lead group of the pack, will be for a sector that has just been purged from the cache.

Typically, a disk cache operates on an Least-Recently-Used (LRU) algorithm, so the no-longer-in-cache sector will likely comprise the sector requested by the one hard disk drive having the greatest differential progress between its copy and the next more advanced one so a split occurs: The pack of hard disk drives being copied are typically observed to divide into two groups, the lead group and the trailing group, each group having a lead drive (which may change frequently) always requesting an out-of-cache sector, and other drives receiving their sector data from the cache filled by the leader. Even so, the individual groups can continue to spread, and either group could potentially split again. Occasionally, a trailing group may outpace the one ahead and suddenly find that its sector requests all reside in cache and the groups recombine. If this behavior remains unaddressed for a large copy job to a group of substantially identical hard disk drives, behavior can lead to a portion of the hard disk drives finishing the copy job several minutes before later groups.

One strategy to ameliorate this problem calls for providing enough memory (typically random access memory or RAM) in server 121. Thus, for a copy job of a particular size, given the statistical rate at which a group's copy progress spreads out, the size of the RAM cache available to the operating system is unlikely to be exceeded. For example, if over the course of copying 100 GB (an exemplary-sized copy job containing about 200 million half-kilobyte sectors), in a group of N hard disk drives (e.g., where N is 64 when all drive bays in the array 200 are populated and allocated to a single replication job), if the likely spread between the most advanced copy and the least advanced copy was 5 GB (about 10 billion sectors), then providing and allocating 5 GB of RAM to the operating system for use caching the source media will substantially reduce the delay between the first and last finishing hard disk drives. Since more than one replication job runs at a time, that same allocation might be increased by a factor equal to the expected number of simultaneous replication jobs, but only up to a point (if 32 pairs of drives were assigned to 32 jobs, it is unlikely that the pairs would diverge much since in each pair the leader always waits for a sector and the other drive always waits less, so little cache would be needed).

Another strategy calls for delaying the leaders of a group of hard disk drives slightly between individual file copies. For example, if a 100 GB job comprises 10 individual files, then as the leaders complete each file, their onset for copying the next file is delayed to allow the trailing group to at least partially catch up. If a detailed analysis detects that it would be more efficient, then this delay might be only until the trailing hard disk drives in the current group catch up. In this way, the substantial splits in the cache are more likely mitigated, and though the completion time of the first hard disk drive is extended, the completion time of the worst-case hard disk drive is reduced. This is valuable if, for an urgent job, an operator is not called to begin removing hard disk drives (e.g., operational step 164) until the job has completed.

In some instances, one or more hard disk drives could exhibit poor performance in comparison to other drives in the same job. As an example, consider the performance of a native 500 GB hard disk drive and a 1 TB hard disk drive clipped to 500 GB when copying almost 500 GB of content. In such a situation, the natively 500 GB hard disk drive may exhibit slower data transfer than the clipped hard disk drive during the writing of content to the last ⅓ or so of the smaller disk's cylinders. As a result, even the caching strategy described above typically will not keep the native hard disk drive at the same performance level as the clipped hard disk drive. Under such circumstances, the characteristics of slower hard disk drive, whether (1) currently observed while in the COPYING FILES state 950, (2) previously noted in the physical media information database 122, or (3) anticipated from the drive's characteristics, could lead to dropping of the slow hard disk drive from the replication job. This can occur by having the hard disk drive enter the FAIL state 990 (e.g., by transition 995), or perhaps by not assigning the hard disk drive to the replication job at the outset (i.e., not permitting the transition 921). Removing slow drives from replication jobs requiring large numbers of copies can allow such replication jobs to finish more quickly. Assigning hard disk drives known to exhibit mutually similar performance at transition 921 will reduce performance drops due to progress spread that can defeat a caching strategy. In an enterprise that manages hundreds of thousands of drives and thousands of replication jobs per month, undertaking such management techniques by the replication server 121 remain crucial to achieving near-best-possible throughput.

If, during the COPYING FILES state 950 a hard disk drive cannot copy a file or, as discussed above, when monitored by the replication server 121, the hard disk drive appears compromised or threatens the overall speed of the corresponding replication job, the fault transition 995 places the hard disk drive to the FAIL state 990. If the fault appears “soft”, that is, the fault remains unlikely to persist in a subsequent replication job, then the hard disk drive remains subject to several retries and via the transition 991, the hard disk drive can re-enter the pool of drives in the AVAILABLE state 910. However, if the hard disk drive has exhibited too many faults, or the fault appears too severe, then with no retries remaining the transition 992 is taken and the drive transitions to the MAINTENANCE state 912 for advanced testing, conditioning, and repair attempts.

Once copying has completed during the COPYING FILES state 950, then the transition 965 advances the drive to the TESTING state 960. Various strategies exist for testing and include functional testing to ensure that the structure of the file system remains intact. For example, the operating system of the replication server 121 can execute a ‘file system check’ command to check sum each content file and compare the result to a reference value (which may itself be included in the same or different content file). Alternatively, the operating system could undertake a byte-by-byte comparison with the original content. The check sum process has the advantage that each drive can undergo testing independently and doesn't require any cache management strategy as in COPYING FILES state 950. Test strategies can vary by replication job. Whatever the strategy, if a hard disk drive fails a test, then that drive faults with transition 996 to the FAIL state 990. If the hard disk drive tests successfully then by the transition 986, the drive enters the PASS state 980 and remains ready for removal during step 164 of FIG. 1. However, in the case where during step 705 of FIG. 7, the drive's serial number did not associate with a known barcode (e.g., the bar code 413), then instead the transition 976 is taken and the hard disk drive will enter the NEEDS BARCODE SCAN state 970. The hard disk drive will wait while the indicator 333 exhibits an urgent “scan my barcode” indication 443. Upon being scanned, the transition 987 (as discussed above in conjunction with FIG. 7) brings the hard disk drive to the PASS state 980, ready for removal during step 164 of FIG. 1.

If, for some reason, a hard disk drive in the PASS state 980 gets powered down but not removed by an operator and subsequently becomes powered up, the replication server 121 could recognize this condition as the drive enters AVAILABLE state 910. Under such circumstances, the replication server 121 will designate the hard disk drive as unshipped during transition 961 which can cause the drive to enter the TESTING state 960 or cause the drive to directly enter the PASS state 980. Under such circumstances, the replication server 121 of FIG. 1 would undertake a check to mitigate operator errors that could be reasonably expected to occur when handling thousands of drives.

FIG. 10 illustrates the overall drive state transition diagram 1000, in which the IN BAY state 1020 represents the entirety of the states and conditions described with respect to FIG. 9 (except EMPTY BAY state 901). A newly acquired hard disk drive enters the NEW DRIVE state 1001, whereupon the drive, if not initially provided with one by the manufacturer, receives a barcode (e.g., bar code 413), which may or may not be known to the system. The new hard disk drive undergoes stocking during the transition 1011, thereby entering the inbound inventory 140 of FIG. 1 following scanning of the bar code by the barcode scanner 132 of FIG. 1. In this way, the hard disk drive enters the READY INVENTORY state 1010 of FIG. 10. During normal operations, an operator may pull the hard disk drive from the inventory 140 of FIG. 1 producing the transition 1021 of FIG. 10 and insert the drive into replication array 123 during step 163 of FIG. 1. As a result, the hard disk drive enters the IN BAY meta-state 1020 of FIG. 10 corresponding to a transition from the EMPTY BAY state 901 of FIG. 9 when the hard disk drive is detected by the replication server 121 and initiates the transition 911 to the AVAILABLE state 910. Processing during IN BAY meta-state 1020 proceeds according to the state diagram 900 of FIG. 9. Upon reaching either of the states 980 or 999 of FIG. 9, the replication server 121 of FIG. 1 awaits operator action to transition out of the IN BAY meta-state 1020. For instances where the hard disk drive was in the terminal state DISCARD 999, the replication server 121 signals an operator to discard the drive, so that upon removal from array 123, the discard transition 1052 occurs and the replication system sets the state of the hard disk drive to the DESTROYED state 1050. The operator accomplishes destruction of the hard disk drive by placing the drive into a bin reserved for subsequent degaussing, crushing, drilling or other destruction according to the disposal policy.

For instances where a hard disk drive enters the terminal PASS state 980, the replication server 121 signals an operator that this drive has become ready for shipping. Thus, upon removal of the hard disk drive during step 164 of FIG. 1 and placement in the outbound inventory 150, the drive undergoes a transition 1032 into the SHIP state 1030. When the operator pulls the hard disk drive from the outbound inventory 150 during step 165 of FIG. 1, the operator will scan the drive's barcode 413 with the barcode scanner 133 so the replication server 121 can generate the shipping label 135. The replication server 121 will consider this hard disk drive as shipped during transition 1043 and the driver enters the OUT state 1040, even before actually completing the shipping step 166 of FIG. 1.

In some example embodiments, the OUT state 1040 could undergo division into sub-states on the basis of information obtained from a logistics server (not shown) operated by the shipping company (not shown). In such an embodiment, sub-states may comprise the following: “AWAITING PICKUP”, “PICKED UP”, “IN ROUTE”, “DELIVERED”, “DELIVERY FAILED”, etc. In other exemplary embodiments, the shipping label 135 can uniquely identify the shipment using information obtained independently from the logistics server operated by the shipping company.

After entering the OUT state 1040, a hard disk drive will re-enter the system after being returned after some amount of time (generally weeks or months) by the movie theater following exhibition of the content contained on the drive. Therefore, upon receipt of a hard disk drive during step 161 and following scanning of that drive by barcode scanner 132 and restocking into inbound inventory 140 during step 162, the hard disk drive undertakes transition 1041 and returns to the READY INVENTORY state 1010. In some cases, where a drive remains unreturned for an extraordinary amount of time (e.g., several months), its OUT status 1040 may timeout with the transition 1064 and the drive will enter the LOST state 1060. Designating an unreturned hard disk drive as lost has benefits for inventory management purposes to detect and track shrinkage. Designating a drive as lost may be advantageous for tax purposes, or can trigger an inquiry (or a bill) sent to the recipient of the missing drive. If, at some point, the missing drive unexpectedly and miraculously returns during transition 1061, the hard disk drive will enter the READY INVENTORY state 1010. For this reason, the LOST state 1060 does not necessary constitute a terminal state in the state diagram 1000, unless as a matter of business policy, once a drive considered lost, it is never returned to use.

Thus, as far as system 100 is concerned, the life cycle of a hard disk drive, as shown in diagram 1000, begins at state 1001 when the hard disk drive is first placed into stock 1011, and cycles repeatedly through states 1020, 1030, and 1040, returning to the inventory state 1010 until at some point (barring loss) many cycles later, the drive fails with the transition 916, and as a result becomes destroyed following transition 1050.

The foregoing describes a system and method for improved replication of content onto one or more storage devices.

1. A method for replicating content onto a storage device, comprising, steps of:
prioritizing a set of content replication jobs in accordance with work orders associated with such content replication jobs to establish a current highest priority content replication job of the set;
downloading content specified in the current highest priority content replication job onto a storage device for distribution to a location specified in the work order associated with the current highest priority content replication job.

2. The method according to claim 1, wherein step of prioritizing the set of jobs accounts for at least one of the following parameters, (a) due dates, (b) delivery schedules, (c) content availability, (d) explicitly supplied work order priorities and (e) work order priority policies.

3. The method according to claim 1 wherein the downloading step further comprises steps of:
(a) detecting a first identification of the storage device inserted into a storage device bay;
(b) copying the content specified onto the storage device while in the bay;
(c) recording an association between the storage device and the job;
(d) removing the storage device from the storage device bay following content copying.

4. The method according to claim 3 further including step of generating a shipping label for the storage device following removal of the storage device from the storage bay based on a second identification of the storage device and the association between the storage device and the job.

5. The method according to claim 3 further comprising step of displaying an indicator indicative of at least one of steps of (a)-(d).

6. The method according to claim 4 further comprising step of displaying an indicator indicative of all of steps (a)-(d).

7. The method according to claim 5 wherein step of displaying the indicator further comprises displaying one of a plurality of animations.

8. The method according to claim 7 wherein each of the animation varies in accordance with at least one of color, brightness and speed.

9. The method according to claim 8 wherein at least one animation comprises a pulsed light.

10. The method according to claim 9 wherein the animation comprises a pulsed light of alternating colors.

11. The method according to claim 7 wherein at least one animation has increased brightness to indicate urgency.

12. The method according to claim 3 wherein step of identifying the storage device includes scanning identifying indicia on the storage device.

13. The method according to claim 12 wherein the identifying indicia identifies a serial number of the storage device.

14. A system for replicating and distributing content, comprising:
a replication system responsive to work orders each specifying one or more content replication jobs and to policies for prioritizing the content replication jobs to establish a first current highest priority content replication job, and able to download content specified in the first replication job onto at least one storage device; and
a distribution system for distributing the storage device downloaded with the content specified in the first replication job to a location specified in the work order associated with the first replication job.

15. The system according to claim 14 wherein the replication system comprises:
a storage bay for holding a plurality of storage devices;
a content store for storing content for copying onto at least one storage device held in the storage bay;
a storage device database for storing information about the at least one storage device held in the storage bay; and
a replication server for prioritizing the content replication jobs according to the policies to establish the first replication job, and for downloading content specified in the first replication job onto the least one storage device held in the storage bay in accordance with the information for that storage device held in the storage device database.

16. The system according to claim 15 further comprising at least one indicator controlled by the replication server to indicate status of the at least one storage device loaded into the storage bay.

17. The system according to claim 16 wherein the at least one indicator displays one of a plurality of animations.

18. The system according to claim 17 wherein each of the plurality of animations varies in accordance with at least one of color, brightness and speed.

19. The system according to claim 18 wherein at least one animation comprises a pulsed light.

20. The system according to claim 19 wherein the animation comprises a pulsed light of alternating colors.

21. The system according to claim 17 wherein at least one animation has increased brightness to indicate urgency.

22. The system according to claim 14 wherein the distribution system comprises:
a scanner for scanning identifying indicia on the storage device downloaded with the content specified in the first replication job;
a logistics server for retrieving shipping information from the work order associated with the first replication job with the identifying indicia scanned by the scanner; and
a shipping label printer responsive to the logistics server for printing a shipping label in accordance with the shipping information.
